(19) United States
(12) Patent Application Publication
(10) Pub. No.: US 2013/0264507 A1
(43) Pub. Date: Oct. 10, 2013

(54) SOLENOID VALVE

(71) Applicants: Franz-Josef Schnelker, Neuss (DE); Werner Buse, Kaarst (DE); Christoph Sadowski, Bochum (DE); Rolf Lappan, Koeln (DE); Rolf Dohrmann, Kaarst (DE); Lukas Romanowski, Osnabrueck (DE)

(72) Inventors: Franz-Josef Schnelker, Neuss (DE); Werner Buse, Kaarst (DE); Christoph Sadowski, Bochum (DE); Rolf Lappan, Koeln (DE); Rolf Dohrmann, Kaarst (DE); Lukas Romanowski, Osnabrueck (DE)

(73) Assignee: PIERBURG GMBH, NEUSS (DE)

(21) Appl. No.: 13/994,133

(22) PCT Filed: Nov. 15, 2011
(86) PCT No.: PCT/EP2011/070120

§ 371 Date: Jun. 14, 2013

(30) Foreign Application Priority Data
Dec. 17, 2010 (DE) 102010055026.4

(51) Int. Cl. F16K 31/04

(52) U.S. Cl. CPC F16K 31/04
USPC 251/129.15

(57) ABSTRACT

A solenoid valve includes a plug connection, at least one valve sleeve comprising at least one valve seat, at least one valve closure element which acts on the at least one valve seat, and a housing. Within the housing are arranged a core, a coil, an armature/plunger arrangement, and a multiple-part return-path arrangement, which together form an electromagnetic circuit. The coil is wound onto a coil former. The armature/plunger arrangement is movable and acts directly or indirectly on the at least one valve closure element. The armature/plunger arrangement is mounted in the coil former via a bearing and comprises at least one armature part and a plunger part. The plunger part is arranged in the valve sleeve and is moveable therein. The armature part is mounted in the coil former via the bearing. The armature part and the plunger part are connected to each other via the plug connection.

### CROSS REFERENCE TO PRIOR APPLICATIONS

This application is a U.S. National Phase application under 35 U.S.C. §371 of International Application No. PCT/EP2011/070120, filed on Nov. 15, 2011 and which claims benefit to German Patent Application No. 10 2010 055 026.4, filed on Dec. 17, 2010. The International Application was published in German on Jun. 21, 2012 as WO 2012/079888 A1 under PCT Article 21(2).

### FIELD

The present invention relates to a solenoid valve with a housing which accommodates a coil wound on a coil former, an armature/plunger arrangement, a core, and a multiple-part return-path arrangement, which form an electromagnetic circuit, wherein the armature/plunger arrangement comprises at least one armature part and one plunger part, and the movable armature/plunger arrangement is supported in the coil former through bearing means and acts either directly or indirectly on at least one valve closure element, wherein the valve closure element engages at least one valve seat arranged in a valve sleeve.

### BACKGROUND

Various fields of application in internal combustion machines have been described for solenoid valves. Solenoid valves are used both in pneumatic and in hydraulic circuits in vehicles, such as in brake equipment, brake systems or injection systems. They can moreover be used, for example, to control the pressure of pneumatic actuators or as divert-air valves in turbochargers. Depending on the field of application, these solenoid valves are configured either as open/close valves or as proportional control valves.

A solenoid valve configured as a pressure control valve has been described, for example, in DE 10 2007 002 465 A1. This pressure control valve is used in a hydraulic system, in particular in a high-pressure fuel system. The plunger part with the valve closure element is connected with the armature part of the solenoid valve in a manner not described in detail.

Against the background of an automated manufacture of solenoid magnets for various applications with different valve sleeves and different valve closure elements, a module-like structure of the solenoid valve is desirable where different types of plunger parts can be used in a simple manner. This is not possible with the solenoid valve described in the prior art.

### SUMMARY

An aspect of the present invention is to provide a solenoid valve that avoids the above-mentioned disadvantage.

In an embodiment, the present invention provides a solenoid valve which includes a plug connection, at least one valve sleeve comprising at least one valve seat, at least one valve closure element configured to act on the at least one valve seat, and a housing. Within the housing are arranged a core, a coil, an armature/plunger arrangement, and a multiple-part return-path arrangement, which together form an electromagnetic circuit. The coil is wound onto a coil former. The armature/plunger arrangement is configured to be movable and to act directly or indirectly on the at least one valve closure element. The armature/plunger arrangement is mounted in the coil former via a bearing and comprises at least one armature part and a plunger part. The plunger part is arranged in the valve sleeve and is configured to be moveable therein. The armature part is mounted in the coil former via the bearing. The armature part and the plunger part are connected to each other via the plug connection. With such an arrangement, a solenoid valve of modular structure can be finished in a simple and economic manner during final assembly, the valve being suited to provide an electromagnetic circuit for different valve designs.

### BRIEF DESCRIPTION OF THE DRAWINGS

The present invention is described in greater detail below on the basis of embodiments and of the drawings in which:

FIG. 1 shows a sectional view of a solenoid valve of the present invention; and

FIG. 2 shows a subassembly drawing for solenoid valve designs to be manufactured in various ways.

### DETAILED DESCRIPTION

In an embodiment of the present invention, the armature part has a pin and the plunger part has a recess corresponding to the pin, such that a force-fit or a form-fit connection can be established. It is thereby possible to finish the solenoid valve in its specific embodiment by a simple plug-in operation during final assembly. It may here be advantageous if the plug-in connection is adjustable in the axial direction. This can be achieved, for example, by providing the pin with a knurling. This allows for a fine adjustment after final assembly. With respect to a simple and thus economic pre-assembly, it is advantageous if at least parts of the return-path arrangement are arranged in the coil former. Due to the fact that a portion of the core opposite the armature part has a larger diameter than a portion of the coil former opposite the valve closure element, the components of the solenoid valve forming the electromagnetic circuit can be preassembled in a simple manner.

In an embodiment of the present invention, a portion of the coil carrier comprises a bearing sleeve for the armature part. It is also possible to configure this portion of the coil former as a bearing portion for the armature part.

It is here advantageous if the coil former is manufactured by an injection molding process with the coil former advantageously being formed from a dimensionally and temperature stable material, such as, for example, Grivory® HT2V 3HLV or Grivory® XE3881.

Embodiments of the present invention are illustrated in the drawing and will be described hereunder.

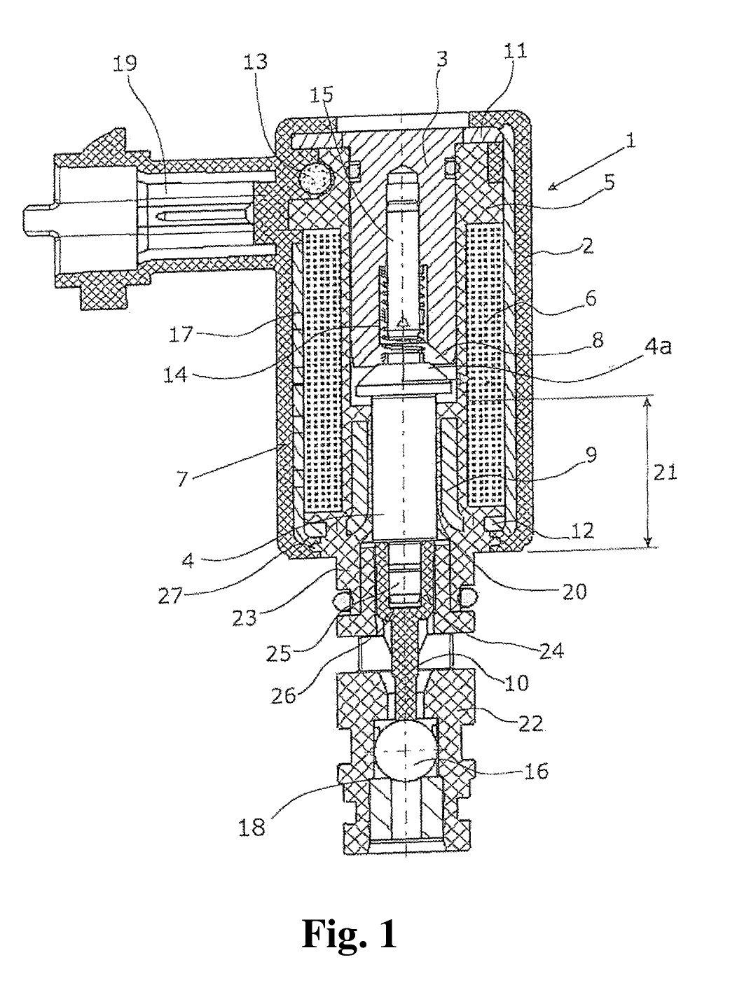

FIG. 1 illustrates a solenoid valve 1 of the present invention in sectional view, the valve being used as an oil pressure control valve. This solenoid valve 1 comprises a housing 2 in which a core 3, an armature part 4, a coil former 5 with a coil 6 wound thereon, and a return-path arrangement 7 are arranged. In the present case, the armature part 4 is connected with a plunger part 10 through a plug connection, which plunger part 10 acts on a valve closure element 16 in a manner known per se. The plunger part 10 moves in a valve sleeve 22 inserted in a receiving bush 23 formed on a side of the coil former 5 opposite the core 3, wherein the receiving bush 23 is integrally connected with the coil former 5. A valve seat 18 is arranged in a valve sleeve 22.

Such a solenoid valve, whose functionality is known per se, operates as follows: In the de-energized state, a gap 8 exists between the armature part 4 and the core 3, in which a magnetic field is generated when the coil 6 is energized, whereby an axial movement of the armature part 4 is caused. The plunger part 10 connected with the armature part 4 is also correspondingly moved, and the valve closure element 16 is released.

In the present embodiment, a return-path inner section 9 is formed integrally with the return-path cover section 12 averted from the core 3, and is arranged in a manner integrated in the coil housing 5. The return-path inner and cover sections 9, 12 have here been included when the coil former 5 was manufactured in an injection molding process. An interference suppression resistance 13 is already provided in the coil former 5. In this manner, essential components can be provided in the coil former 5 during pre-assembly. During the manufacture of a standard coil component, it is thus only necessary to select the coil 6 chosen for the valve function and to mount it on the coil former 5. After the second return-path cover section 11 has been placed and the return-path side section 17 has been engaged in a pressed connection with the return-path cover sections 11, 12 such that an electromagnetic circuit can be formed, and the contacting with an electric plug 19 has been made, the solenoid valve 1 is finished by being overmolded with the (outer) housing 2. In doing so, a contour is provided between the (outer) housing 2 and the coil former 5 which provides a kind of labyrinth-like seal 27 in order to increase the effect of sealing from the atmosphere.

In the present case, the solenoid valve is then finished by arranging the core 3, the armature part 4 and the associated components, such as a spring 14 that, in the present case, maintains the armature part 4 under a bias, as well as a stop pin 15 adjustably provided in the core 3. It is here useful for positioning if a portion of the core 3 opposite the armature part 4 has a larger diameter than a portion of the coil former 5 opposite the valve closure element 16.

In the present embodiment, bearing means 20 for the armature part 4 are formed by the coil former 5, the bearing region 21 substantially coinciding with the region in which the return-path inner section 9 is provided. This embodiment becomes possible due to the fact that a first part 4a of the armature part 4, facing towards the core, has a diameter that is larger than the inner diameter of a portion/bearing region 21 of the coil former 5. Besides the advantage with respect to assembly, this is advantageous in that the bearing region 21 of the coil former 5 is positively reinforced by the inclusion of the return-path inner section 9. By applying a sliding layer in the bearing region 21, it is provided that the armature part 4 slides in the coil former with as little resistance as possible. The coaxial guiding of the armature part 4 in the solenoid valve is provided by the double function of the coil former 5 which, on the one hand, receives the core 3 and, on the other hand, acts as bearing means for the armature part 4. It is also possible to provide a bearing bushing, which is not illustrated in detail herein, in the bearing region 21.

For final assembly, the plunger part 10 chosen for the valve function only has to be plugged on the armature part 4 to establish a plug connection 24. For this purpose, the armature part 4 comprises a pin 25 which is adapted to be inserted into a recess 26 in the valve plunger 10 and which is thereby connected with the same by force-fit or form-fit. The pin 25 may here further comprise a knurling, not illustrated in detail, by which the height of stroke can be adjusted. In the present embodiment, the plunger part 10 is mounted during final assembly, together with the valve sleeve 22. It is also conceivable to provide a valve sleeve that is integrally connected with the coil former 5.

Coaxiality errors can be avoided due to the fact that in this case a part of the coil former 5 is formed as a receiving bush 23 for the valve sleeve 22. It has proven advantageous to have the coil former 5 formed from a dimensionally and temperature stable material such as, for example, Grivory® HT2V 3HLV, Grivory® XE388, PPA or PA 4.6.

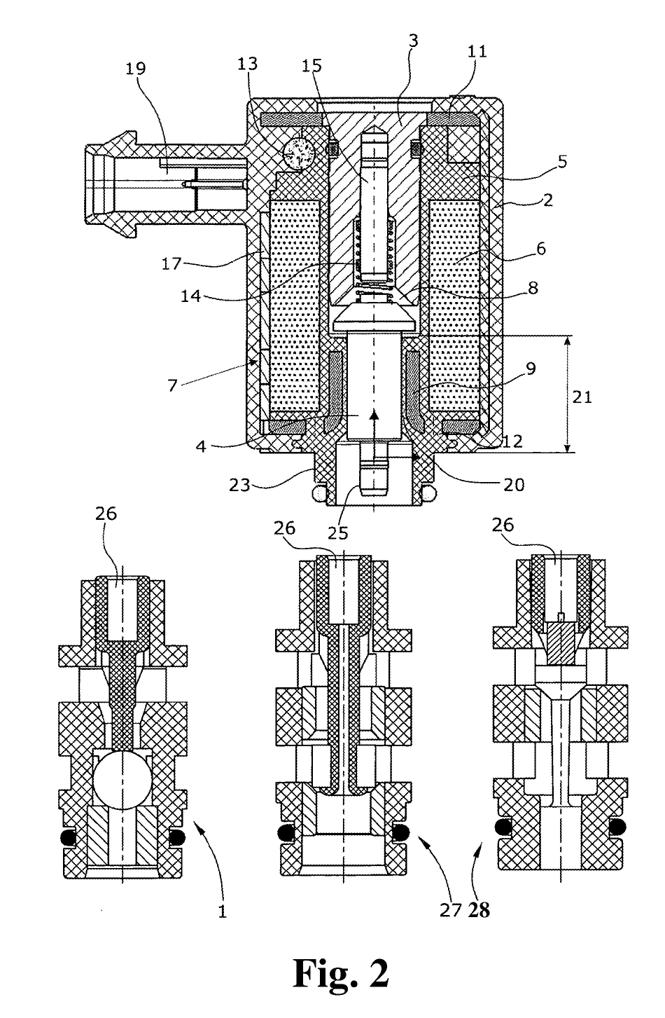

FIG. 2 is a schematic subassembly drawing for different solenoid valves that can be manufactured by simply plugging and thereafter joining the receiving bush 23 and the valve sleeve 22, for example, in a welding process. The bottom left part in FIG. 2, in combination with the top part in FIG. 2, represents the solenoid valve/pressure control valve 1 shown in FIG. 1. The bottom central part in FIG. 2 in combination with the top part in FIG. 2 forms a solenoid valve as a 3/2 slide valve 27, and the bottom right part in FIG. 2 in combination with the top part in FIG. 2 provides a solenoid valve as seat valve 28.

The present invention is not limited to embodiments described herein; reference should be had to the appended claims.

What is claimed is:

1-10. (canceled)

11. A solenoid valve comprising:
a plug connection;
at least one valve sleeve comprising at least one valve seat;
at least one valve closure element configured to act on the at least one valve seat; and
a housing within which are arranged:
a core,
a coil wound onto a coil former,
an armature/plunger arrangement configured to be movable and to act directly or indirectly on the at least one valve closure element, the armature/plunger arrangement being mounted in the coil former via a bearing and comprising at least one armature part and a plunger part, the plunger part being arranged in the valve sleeve and being configured to be moveable therein, armature part being mounted in the coil former via the bearing, the armature part and the plunger part being connected to each other via the plug connection, and
a multiple-part return-path arrangement,
wherein the core, the coil, the armature/plunger arrangement, and the multiple-part return-path arrangement together form an electromagnetic circuit.

12. The solenoid valve as recited in claim 11, wherein the armature part comprises a pin and the plunger part comprises a recess which corresponds to the pin so as to establish a force-fit connection or a form-fit connection.

13. The solenoid valve as recited in claim 12, wherein the pin comprises a knurling.

14. The solenoid valve as recited in claim 11, wherein the plug connection is adjustable in an axial direction.

15. The solenoid valve as recited in claim 11, wherein the multiple part return-path arrangement comprises parts which are arranged in the coil former.

16. The solenoid valve as recited in claim 11, wherein the core comprises a part with a diameter arranged opposite the armature part, and the coil former comprises a part with a diameter arranged opposite the valve closure element, and the diameter of the part of the core arranged opposite to the armature part is larger than the diameter of the part of the coil former arranged opposite the valve closure element.

17. The solenoid valve as recited in claim 11, wherein the coil former comprises a portion with a bearing bush for the armature part.

18. The solenoid valve as recited in claim 17, wherein the portion of the coil former is configured as a bearing portion for the armature part.

19. The solenoid valve as recited in claim 11, wherein the coil former is formed using an injection molding process.

20. The solenoid valve as recited in claim 11, wherein the coil former is formed from a dimensionally and temperature stable material.

21. The solenoid valve as recited in claim 20, wherein the dimensionally and temperature stable material is selected from Grivory® HT2V-3H LF or Grivory® XE3881.
